(19) United States
(12) Patent Application Publication
(10) Pub. No.: US 2011/0013244 A1
(43) Pub. Date: Jan. 20, 2011

(54) Controllable Deflection Device

(75) Inventor: Gerald Futterer, Dresden (DE)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SeeReal Technologies S.A., Munsbach (LU)

(21) Appl. No.: 12/919,786

(22) PCT Filed: Feb. 12, 2009
(86) PCT No.: PCT/EP09/51622

§ 371 Date: Aug. 27, 2010

(30) Foreign Application Priority Data
Feb. 28, 2008 (DE) 10 2008000438.3

(51) Int. Cl. G03H 1/08; G02B 26/08

(52) U.S. Cl. 359/9; 359/315; 359/316

(57) ABSTRACT

A visibility region produced through superimposed light bundles is tracked within a large angular range in front of a light modulator through controllable electrowetting cells having a prism function. Negative effects of buckling of the light bundle cross section are minimized by deflecting the light bundle in the prism cell. Light bundles, modulated by a controllable light modulator, impinge the modulator cells with a defined intensity distribution and pass by a controllable deflection device including a prism cell and a controllable electrode arrangement that adjusts boundary surfaces between a plurality of non-mixable materials. The altered intensity distribution is compensated in the light path of the light bundle in the visibility region by reducing the intensities of secondary diffraction order maxima such that the effective surface of a modulator cell has a shape that is tailored to the altered intensity distribution.

The present invention relates to a controllable deflection device comprising a controllable prism cell which deflects a bundle of rays which is emitted by a controllable modulator cell towards an observer eye in a visibility region in an observer plane. Inside the prism cell, which works on the basis of an electrowetting cell, an interface between two immiscible materials is controlled, where the variable inclination of said interface generates at least one wedge angle for deflecting the bundle of rays in the prism cell with the help of an electrode arrangement which is controlled by control means. The bundle of rays which falls on the modulator cell has a defined intensity distribution.

The controllable deflection device can be applied in a light modulator device comprising a light modulator which contains regularly arranged modulator cells for modulating bundles of rays. Each modulator cell is assigned with a controllable deflection device. The light modulator device which is fitted with the present invention can for example be used in a holographic display which holographically reconstructs a 3D scene for at least one observer and which he sees from his visibility region. The deflection device is connected by software means with a position detection system through the control means in order to determine the position information of the observer eyes and thus the deflection angles of the bundles of rays from the optical axis of the display device towards the observer eye.

The visibility region is also referred to as ‘observer window’ in other documents filed by the applicant; it is generated in an observer plane in front of the display by way of superposition of bundles of rays. It is at least as large as an eye pupil of an observer eye. This means that the right and left perspective of the holographic reconstruction of the scene are generated one after another for the respective right and left observer eye, so that the entire reconstruction is provided to the observer with the correct perspective with respect to his eye position in the visibility region. Several diffraction orders of the diffracted light occur in the observer plane. The diffraction orders are generated according to this invention by diffraction of the light by the individual modulator cells and the corresponding prism cells. The visibility region of an observer eye shall preferably always lie in a region between two diffraction orders for tracking. In this document, the 0^{th} diffraction order coincides roughly with the optical axis of the display device which is fitted according to this invention. If the observer eye is situated in diffraction orders which lie further away from the 0^{th} diffraction order, accordingly weaker intensities reach the neighbouring eye or get into the visibility region of that eye. This means, that mutual cross-talking of the information of both eyes occurs. If the intensities of these diffraction orders exceed a certain degree, e.g. 5% of the intensity in the generated visibility region, then cross-talking to the neighbouring observer eye is perceived as a disturbance when watching the holographic reconstruction. The diffraction pattern of the entire light modulator results from the superposition of the diffraction patterns of the individual modulator cells.

Cross-talking, i.e. the perception of diffraction orders in a neighbouring visibility region, can be suppressed wholly or partly e.g. with the help of a pixel apodisation. The term ‘pixel’ shall be understood here as a modulator cell. Pixel apodisation can be achieved using a number of methods with the help of an apodisation profile t_{SLM pixel} (x,y). If the fill factor FF of a single modulator cell is for example FF>0.5, and if the area of the modulator cell is not too small, then a specific selection of the transmission curve of the individual modulator cell serves to achieve that intensities of the diffraction orders do not disturb the neighbouring eye.

In certain applications, those measures alone will not suffice. Moreover, further problems arise when using optical components which serve to realise a tracking function in the display and which track bundles of rays to moving observer eyes through a large angular range. A deflection device which preferably functions according to the working principle of an electrically variable surface tension, i.e. of an electrowetting cell, is an example of such a component which is suitable for tracking. A multitude of such deflection devices which are regularly arranged in a cell array can be used in a light modulator device to deflect bundles of rays.

As is generally known, an electrowetting cell comprises a container with e.g. at least two different materials or liquids, such as oil and water, whose interface can realise a lens and/or prism function when the electrodes being controlled by applied voltage. The applied voltage can cause the interface within the cell to be shaped as a plane and be inclined variably around at least one axis, so that the materials form two controllable micro-prisms with a certain prism wedge each. This type of cell will be referred to hereunder as a prism cell. When it passes the inclined interface between the micro-prisms, an incident bundle of rays is deflected by a certain angle and can thus be used to generate the tracked visibility region in the observer plane of the holographic display. The visibility region is tracked by varying the inclination of the interface and thus of the deflection angle of the bundles of rays if the observer moves in front of the display. When doing so, it is a disadvantage that the cross-section of the bundle of rays is compressed when it is deflected at the interface. At a deflection angle of e.g. 25°, an axially symmetric bundle of rays is compressed to about half of its original dimension in the direction of deflection. When it is compressed, the area on which the intensity of the bundle of rays is concentrated will become smaller. This also reduces the effective fill factor FF of a modulator cell which forms a functional unit together with a prism cell.

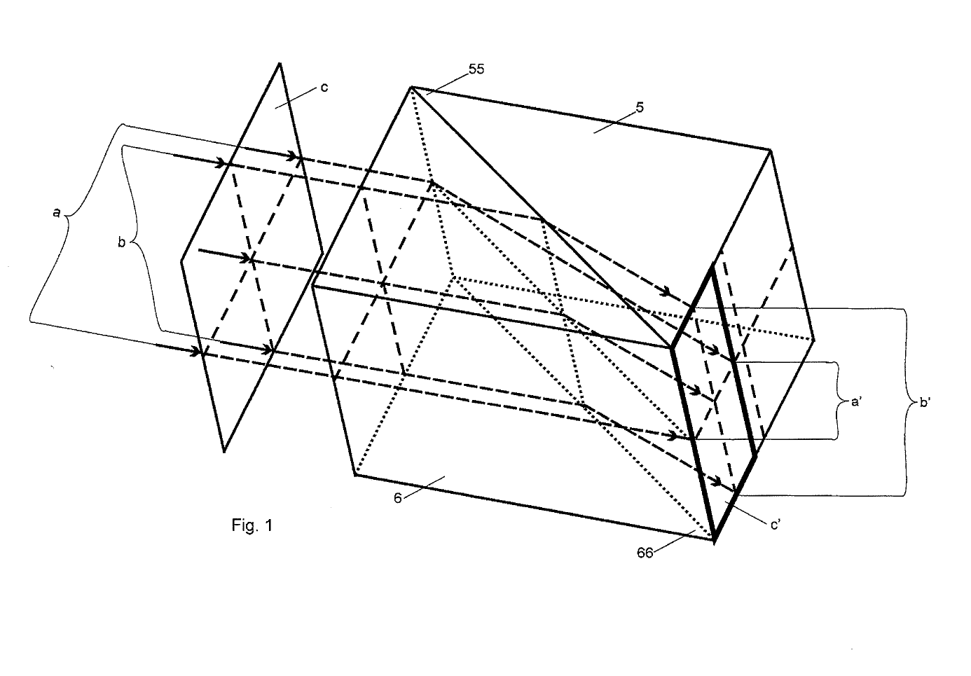

FIG. 1 illustrates schematically the compression for a certain deflection angle of a bundle of rays after its passage through the controllable interface between two materials. An incident bundle of rays with a two-dimensional extent a, b has an almost square cross-sectional area c. For the sake of clarity, only selected outline rays of the bundle of rays are shown as broken lines in the drawing. The optical path through the micro-prisms 5, 6 is indicated by arrows. The micro-prisms 5, 6 were formed through the inclination of the controllable interface between two different, immiscible liquids and have respective wedge angles 55, 66, which are here for example 31°. While the incident bundle of rays is deflected by the inclined interface it is also compressed in the direction of deflection. The cross-section of the bundle of rays is compressed during this deflection such that its area c′ is only ⅓ of the original area c and that it has a rectangular shape a′, b′ when it leaves the micro-prism 5. This is illustrated in the drawing by the bold line the area c′ is outlined with.

A fill factor FF=0.8 of a modulator cell which is assigned with a prism cell with the micro-prisms 5, 6 is reduced to 0.8×0.3=0.24 due to this deflection. Within this reduced effective area of a modulator cell, the intensities in neighbouring diffraction orders, i.e. which hit the neighbouring eye, cannot be reduced with an apodisation profile alone.

The more the interface is inclined, the more the bundle of rays is compressed. This has the effect that more energy of the bundle of rays is distributed to neighbouring diffraction orders which lie outside the visibility region. This portion of energy is so large that it is perceived as disturbing cross-talking effect. This compression of the bundle of rays and the cross-talking which goes along with it confines the feature of tracking visibility regions in the space in front of the display to a small angular range. This can for example be prevented by using a light modulator with larger modulator cells which can serve to generate diffraction patterns where the diffraction orders lie closer to each other and to concentrate the intensities of the side peaks to a smaller region. However, using larger modulator cells in a holographic display causes the visibility region to become too small for reliable tracking for a wavelength of for example λ=450 nm.

A further problem occurs when having only two micro-prisms per prism cell, i.e. a single variable interface. The proportion of the intensity of the bundles of rays which is reflected from that interface and which does therefore not reach the observer eye rises as the inclination of the interface between the two micro-prisms increases. It thus makes sense to generate at least three micro-prisms in a prism cell to achieve the deflection, so to minimise this loss of intensity from the beginning.

Summarising, it must be noted that the incident bundles of rays are the more compressed the larger the deflection angle when using electrowetting cells with micro-prisms for deflecting bundles of rays. The fill factor FF of modulator cells which are assigned to prism cells with micro-prisms appears reduced, although the effective area of a modulator cell as such does not change. This disadvantage has the effect that the intensities of the diffraction patterns of the modulator cells are distributed over a larger area as the deflection angle increases, so that intensity portions of side peaks of adjacent diffraction orders also grow so that they are perceived as disturbing cross-talking in the neighbouring eye. The cross-talking can only be reduced while maintaining a large deflection angle to serve a large tracking range by introducing additional measures.

Further disadvantages when tracking a visibility region on the basis of the deflection of bundles of rays by electrowetting cells, which become particularly apparent in conjunction with the use of this feature in holographic display devices, will be discussed below in the context of the description of the Figures.

It is the object of the present invention to provide in a light modulator device a device for tracking in a large angular range a visibility region in an observer plane, said visibility region being generated by bundle of rays, where the tracking is achieved by a deflection of the bundles of rays with the help of controllable micro-prisms. The above-mentioned disadvantages of a deflection by micro-prisms shall be minimised as far as possible. In particular, the effects of a reduced cross-sectional area of the bundles of rays after the deflection, which is caused by compression, shall be compensated almost completely.

The object is solved with the help of a controllable deflection device comprising a controllable prism cell and a controllable electrode arrangement, where the prism cell contains multiple immiscible materials and is assigned to a controllable modulator cell which lies before the prism cell, seen in the direction of light propagation, and which is illuminated with a bundle of rays which contains a defined intensity distribution, where the electrode arrangement controls interfaces which are formed between two immiscible materials inside the prism cell so to deflect the bundle of rays towards a detected observer eye in a visibility region, and where the deflected bundle of rays has a different or changed intensity distribution of the diffraction patterns of the modulator cell in the visibility region compared with the defined intensity distribution.

The object is solved according to this invention in that geometric-optical elements are provided in the optical path in the controllable deflection device which comprise an effective area of a modulator cell and/or the materials in the prism cell. According to this invention, the intensity distribution which is changed in the visibility region is compensated in the optical path of the bundle of rays by reducing the intensities of side peaks of higher diffraction orders in that the effective area of the modulator cell has a shape which is adapted to the changed intensity distribution and/or in that the materials in the prism cell are used such that a homogeneous refractive power distribution is generated at the interfaces. This is to ensure that the intensity distribution lies mainly in the visibility region of the detected eye, and that the diffraction orders in a visibility region which covers the other eye of the observer only receive little energy so that no cross-talking is perceived.

In an embodiment of the present invention, the controllable deflection device is connected through the control means with a position detection system for detecting the position of at least one observer eye in the observer plane in order to generate at least one wedge angle depending on the position of the detected observer eye.

Further, according to this invention a tracking range is assigned to the deflection device, where within that tracking range the bundles of rays which generate the visibility region are deflected in accordance with the change in the position of observer eyes.

As a first, simple measure the shape of the modulator cells is modified so to minimise the compression of the bundles of rays. Modulator cells are provided whose effective area has the greatest extent in the direction where the corresponding prism cells generate the greatest deflection of the bundles of rays. Thanks to this design, the extent of the modulator cells is enlarged in the direction of deflection, thus compensating the changed intensity distribution which is caused by the compression of the bundles of rays in that direction. This minimises the effect of the compression of the cross-section of the bundle of rays.

As a second measure for minimising the compression, a prism cell has at least four interfaces of which at least two interfaces between three materials are variably inclined as a voltage is applied such that the refractive power is distributed as homogeneously as possible across the materials. The refractive power is here a measure for the degree of deflection of the prism cell. This is to ensure that the transition of the deflections of the bundle of rays into the subsequent material of the prism cell is as homogeneously as possible at each interface. The homogeneous refractive power distribution can be achieved in a three-part prism cell by different formation of micro-prisms in the prism cell. On the one hand, at least two materials in the prism cell have the same wedge angles of the interfaces so that they form identical micro-prisms, which are mutually arranged such that they oppose each other mirror-symmetrically, seen at a right angle to the optical path. This serves to achieve a minimum compression of the bundles of rays. This solution has the advantage that only a small number of control voltage lines is required per created micro-prism for setting the inclination angles in the direction of deflection.

In a further embodiment of the present invention, at least one polarisation means is provided in the optical path to prevent phase jumps in the tracking range while tracking the visibility region. It gives the bundle of rays to be deflected an input polarisation \vec{E}_{S} perpendicular to a plane along which the visibility region is tracked to the observer eye. The tracking range is confined by the maximum realisable deflection angles of the bundles of rays.

In a further embodiment of the present invention, each modulator cell is given additional intensity values, which serve as correction values, by the control means as soon as the loss of energy of the bundles of rays caused by the deflection and by reflections exceeds a given value in the visibility region. The correction values are preferably stored in and can be retrieved from a correction value table at least for a one-dimensional deflection with continuous value pattern.

In order to expand the visibility region at the position of a detected observer eye in a locally confined manner, additional control signals are generated by the control means for a fast periodic lateral excursion of the generated visibility region at that eye position. The additional control values are preferably added as phase signals and/or amplitude signals to the values which are encoded on the light modulator and/or to the control values for the prism cells in order to realise this locally confined excursion. These additional signals or values are set in dependence on the detected deflection angle of the observer eyes.

In a further embodiment of the present invention, multiple horizontally and/or vertically arranged prism cells are combined to form a group of prism cells which are controllable as one unit, where the angular difference of the bundles of rays in relation to an observer eye which is to be realised between two adjacent prism cells lies below a threshold value. This facilitates the design of an array of prism cells.

In a preferred embodiment, at least one controllable deflection device is assigned to a light modulator, where complex values of the hologram of a holographic reconstruction to be displayed are encoded on the modulator cells of said light modulator, and where said light modulator is passed through by coherent bundles of rays with a defined intensity distribution, which—after being diffracted by the modulator cells and the corresponding downstream deflecting prism cells—are superposed as an intensity distribution of diffraction patterns in a visibility region in an observer plane. The diffraction patterns of a modulator cell are assigned to a corresponding downstream deflecting prism cell. After deflection by the prism cell the bundle of rays exhibits a different intensity distribution. Geometric-optical elements which are provided in the optical path compensate this change such that the intensity of the side peaks of the diffraction patterns of the visibility region of the detected eye is reduced in the visibility region of the other eye. This is achieved in that the effective area of the modulator cell has a shape which is adapted to the changed intensity distribution and/or in that the materials which are used in the prism cell generate a homogeneous refractive power distribution at their interfaces.

In a further embodiment of the invention, the light modulator which is fitted with a multitude of controllable deflection devices is integrated into a light modulator device. The controllable modulator cells are arranged in a regular pattern in the light modulator, and each modulator cell is assigned to a controllable deflection device according to at least one of claims 1 to 10.

The light modulator device can for example be applied in a holographic display device which is used for presenting holographic reconstructions.

The present invention will be described in detail below with the help of embodiments in conjunction with the accompanying drawings, where

FIG. 1 is a perspective view that illustrates the deflection and compression of a bundle of rays by a controllable inclined interface between two immiscible materials,

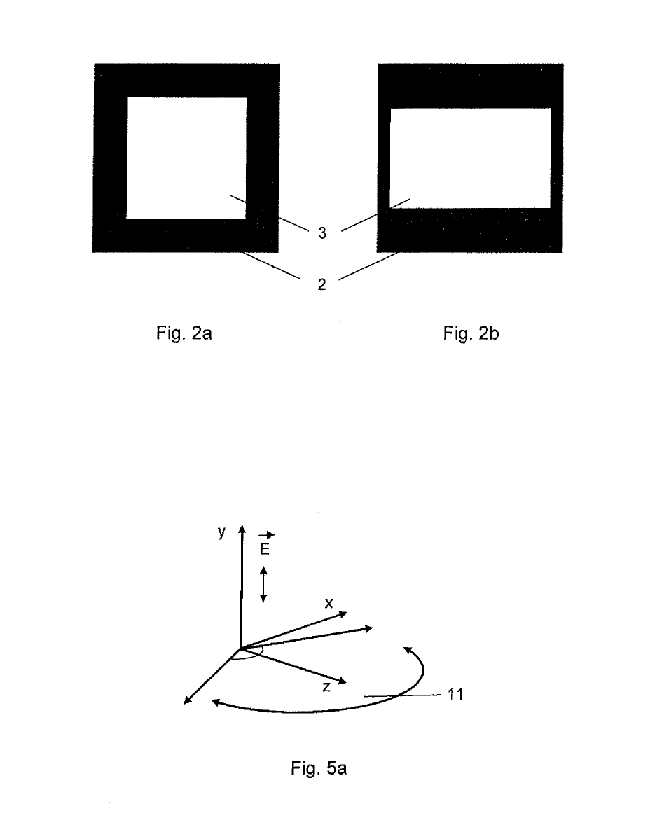

FIG. 2a, 2b show examples of effective areas of modulator cells,

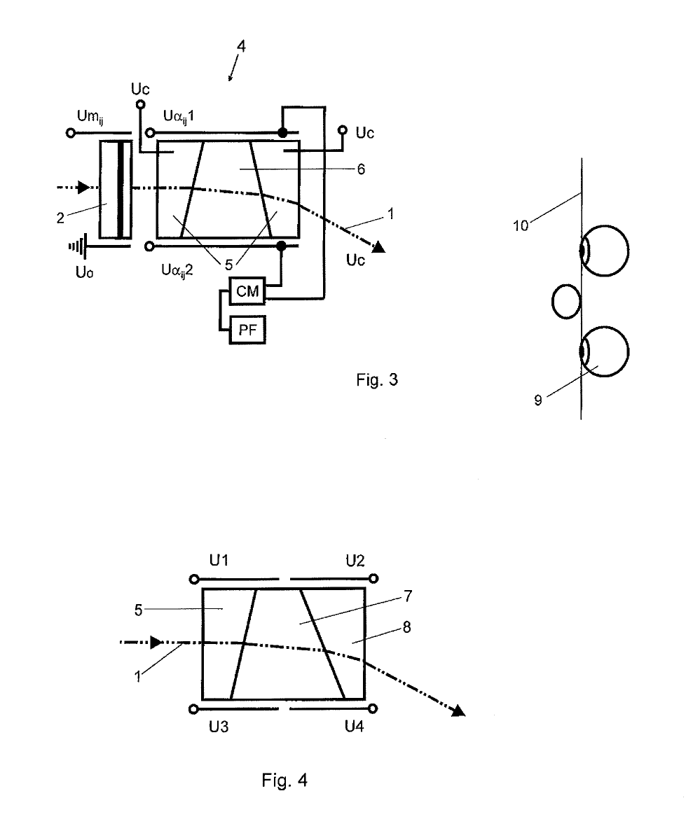

FIG. 3 is a top view which illustrates the optical path of a bundle of rays which is emitted by a modulator cell and deflected towards an observer eye by a controllable prism cell with identically set wedge angles,

FIG. 4 is a top view which illustrates a bundle of rays during its passage through a controllable prism cell with differently inclined interfaces, and

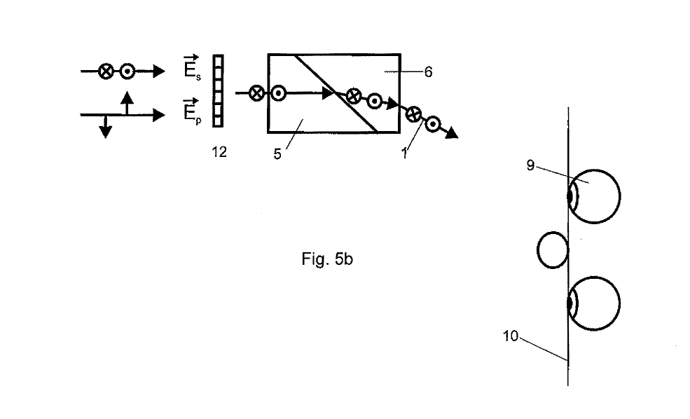

FIG. 5a, 5b illustrate a tracking range of a visibility region with indication of the orientation of the electric field of a polarisation means (FIG. 5a) and a two-part prism cell with the polarisation means (FIG. 5b).

The controllable deflection device according to this invention comprises as major components a prism cell 4 with at least three materials, which are connected with electrode arrangements Uαᵢⱼ1 . . . Uαᵢⱼn for inclining the interfaces which are formed between the materials. Further, control means CM are provided for each prism cell 4 for controlling said electrode arrangements. The indices ij relate to the controllable modulator cell 2 which is assigned to a prism cell and define their position in a light modulator (not shown). The electrode arrangement Umᵢⱼ is provided for controlling the corresponding modulator cells 2. The control means CM are further connected with a position detection system PF. The bundle of rays always enters the first interface of a prism cell at right angles. The individual components are only shown schematically and are reduced to important details in order to facilitate the understanding of the concept of the present invention.

FIG. 1 has already been described in the prior art section above; it serves to generally illustrate the compression which occurs when a bundle of rays is deflected by an electrowetting cell. The representation of further components was omitted in this drawing.

FIGS. 2a and 2b show an effective area 3 of a modulator cell 2, which has a square shape in FIG. 2a and a rectangular shape, which is adapted to the compression, in FIG. 2b.

Referring to FIG. 2b, the extent of the modulator cell 2 is enlarged in the direction of deflection, taking into account the compression in that direction. The total effective area 3 remains the same as in FIG. 2a though. In this embodiment, there is more room above and below the effective area 3 for electrical control lines which are necessary to control modulator cells 2 which are regularly arranged in a light modulator. The effective area 3 shall be understood here to be a surface area through which the bundles of rays 1 pass, or by which they are reflected, thus forming transmissive or reflective modulator cells 2, respectively.

FIG. 3 shows the optical path of a bundle of rays 1 towards the observer eye 9 as a chain line. The bundle of rays 1 passes through a modulator cell 2 and through an assigned prism cell 4 with a defined intensity distribution. In a first embodiment, a controllable deflection device comprises a prism cell 4 with three serially generated micro-prisms 5, 6 which are made of two different materials. Identical micro-prisms 5 are generated in that a control voltage is applied so that the two interfaces are inclined such that identical wedge angles are formed at the interface of the two different materials. The micro-prisms 5 are made of the same material and are arranged in relation to the material which is sandwiched between them such that they oppose each other mirror-symmetrically, seen at a right angle to the optical path. This ensures a widely homogeneous distribution of the refractive power to the subsequent material at each interface, thereby minimising the compression of the bundle of rays 1. Since the bundle of rays 1 falls on the first interface of the prism cell 4 at right angles, this transition from one material to another has no effect on the refractive power distribution.

With this arrangement of micro-prisms, the number of electrodes for each direction of deflection which are necessary to control the micro-prisms 5, 6 can preferably be reduced to only two electrodes Uαᵢⱼ1 and Uαᵢⱼ2. Umᵢⱼ denotes the data lines for the respective modulator cell 2, while U₀ denotes the grounded lines. A constant voltage Uc is continuously supplied to the polar liquid in each prism cell 4, which is typically water. The electrode arrangements of the prism cell 4 are electrically connected via control means CM with a position detection system PF for the detection of the position of the observer eyes 9 which lie in the observer plane 10.

The compression of the cross-section of the bundles of rays 1 can also be minimised when the interfaces in the prism cell 4 are inclined differently. FIG. 4 shows a prism cell where two interfaces between three materials are inclined at different angles. This arrangement generates micro-prisms 5, 7, 8 with different wedge angles in serial arrangement. It is possible to use two or three different materials for this type of prism cell 4. Again, a constant voltage Uc is applied to the polar material, e.g. water. However, due to the different inclinations of the interfaces, the number of electrodes which must be controlled independent of each other for each direction of deflection is increased to four electrodes U1 to U4. This allows to control the respective wedge angle of two micro-prisms 5 and 8. The third wedge angle arises automatically, since the entry and exit surfaces of the prism cell are coplanar. Consequently, if the visibility region is to be tracked to an observer eye in two directions, eight electrodes are necessary per prism cell. However, it is still possible to reduce the number of electrodes where the interfaces are inclined differently by using three different materials. The different materials are here water an oil. The two droplets of water which sandwich the oil differ in their salt concentration.

FIGS. 5a and 5b show schematically the effect a polarisation means 12 has on the deflection of the bundles of rays 1, and illustrate the tracking of the visibility region with the example of a two-part prism cell.

Referring to FIG. 5a, a tracking range 11 in the X-Z plane and an electric field \vec{E} which oscillates perpendicular to that plane are shown in a coordinate system. The bundle of rays and the visibility region will be tracked along that plane to an observer eye if the observer moves. The tracking range 11 is confined by two exemplary arrows in the drawing. It should be as large as possible so to be able to serve multiple observers simultaneously. Observer eyes which lie outside that range cannot be served.

FIG. 5b shows the bundle of rays 1 with its polarised portions \vec{E}_{S} and \vec{E}_{P} which oscillate both parallel and perpendicular to the drawing plane and which fall on a polarisation means 12, e.g. a polarisation filter, which is disposed in the optical path. Only the portion of the bundle of rays which oscillates perpendicular to the drawing plane passes the polarisation filter 12 to enter the micro-prisms 5, 6, which are disposed downstream. That portion is deflected towards the observer eye 9 by the interface.

The electric field \vec{E}_{S} which is still effective in the bundle of rays prevents phase jumps to occur if the prism cell realises large deflection angles. The phase jump which occurs in the \vec{E}_{P} component of the electric field at large deflection angles is described by Fresnel's equations. During tracking, there is a phase jump π roughly every 20° which is perceived as a disturbance. Its occurrence depends on the wedge angle and on the actual refractive indices of the neighbouring micro-prisms 5, 6.

The functional principle of the controllable deflection device according to this invention will now be described in detail with the example of a holographic direct-view display. Only the intensity distribution of the diffraction patterns of the modulator cell in the visibility region which is changed by the deflection in the prism cell and the corresponding compression of the bundles of rays, compared to the defined intensity distribution, is considered in the context of this invention. Any other possible changes in the intensity caused by the modulation of the bundle of rays in the modulator cell is not considered and is not covered by the present invention.

The display comprises a light modulator to which an array of deflection devices is attached which is for example designed as shown in FIG. 3. Complex values which represent the hologram of a holographic reconstruction to be generated are encoded in the controllable modulator cells 2. However, it is also possible that the wave front of the reconstruction to be generated is encoded directly. Coherent bundles of rays 1 illuminate the modulator cells 2, pass through these modulator cells 2 and are thereby modulated with the encoded values, and fall on the respectively assigned prism cells 4 which are disposed downstream. The position detection system PF detects in the observer plane 10 an observer eye 9 towards which the bundles of rays 1 shall be deflected. The three-dimensional coordinates of the observer eye 9 are detected. This position information forms the basis for the control means CM to determine the deflection angle of the observer eye 9 in relation to the optical axis of the light modulator or display device. The interfaces between the adjacent materials are inclined depending on the determined deflection angle by the accordingly addressed electrodes Uαᵢⱼ1 and Uαᵢⱼ2. Thereby, micro-prisms 5, 6 with a wedge angle which realises the required deflection are formed depending on the inclination of the interfaces.

Each prism cell is addressed and controlled independently of the other prism cells in an array of prism cells. This makes it possible that an individual direction of propagation can be set for each bundle of rays which is emitted by the prism cells, and which can realise at least one complex value of the hologram. However, it is also possible that multiple prism cells of an array are combined horizontally and/or vertically by software means so to form small groups. This can be done particularly in the case where the maximum angular difference of the bundles of rays which is to be realised between adjacent prism cells, seen from the observer eye, is below a certain threshold value. These prism cells would receive identical control signals. A group of such prism cells can then be controlled with a common control signal. The number of control signals can be reduced or they can be combined and the control process to be carried out by the control means can be simplified. The required data rate can thereby preferably be reduced, e.g. in a holographic display.

The coherent modulated bundles of rays 1 leave the prism cells 4 in the form of a distribution of diffraction patterns of the modulator, cells 2 and are superposed at the position of the observer eye 9, where they generate a visibility region. Such a visibility region is generated for each detected observer eye of an observer. At the same time as they are deflected, the bundles of rays 1 are compressed, whereby the defined distribution of the intensities of the diffraction patterns is changed. The energy (intensity) which is available in the observer plane 10 is distributed there across a larger area. This distribution causes the intensities of the side peaks of the higher diffraction orders to rise, so that cross-talking to the neighbouring eye and thus into the adjacent visibility region is perceived.

Geometric-optical means which are disposed in the optical path can counteract the compression of the bundles of rays and thus reduce the cross-talking among neighbouring observer eyes to such a degree that an observer does not perceive it as a disturbance any more. This can be achieved by implementing one of the two measures or a combination thereof.

The first, simple measure is to modify the effective area of the modulator cells of a light modulator and thus to redesign the modulator cells. For minimising the effects of the compression of the bundles of rays, a modulator cell is preferably given a larger extent in the horizontal direction, i.e. in the direction of deflection of the bundles of rays. This increases the effective area of the bundle of rays and creates an intensity distribution where the intensities of the side peaks can only be perceived very weakly or not at all.

The second measure minimises the compression of the bundles of rays in that the refractive power is distributed as homogeneously as possible across the materials in an arrangement with at least two controllable interfaces between three adjacent materials which are generated by at least three micro-prisms. As already described above, the three micro-prisms can be generated to distribute the refractive power to prism wedges of different sizes in a symmetric or asymmetric arrangement.

As far as the control is concerned, a symmetric arrangement as shown in FIG. 3 is preferably used. In such arrangement, at least two identical micro-prisms 5 are generated which oppose each other mirror-symmetrically in relation to the third micro-prism 6 by way of accordingly controlled inclination of the interfaces. Only oil and water are required as liquids, for example. The sequence of materials in the prism cell 4 is water-oil-water. The compression of the cross-section of the bundle of rays 1 is thereby minimised by identical wedge angles of two micro-prisms. The symmetry of the micro-prisms 5 to be generated will persist if the inclinations of the controllable interfaces are varied in dependence on the position of the observer eye 9.

Theoretically, the sequence of the materials in the prism cell 4 can also be inverted, but simulations have shown that the transmittance is worse and the bundles of rays are still more compressed at the same deflection angle.

As the deflection angle grows the luminous intensity which is perceived by the observer eye decreases. This decrease has basically two different reasons. On the one hand, the larger the wedge angle the larger is the portion of the light which is reflected from the interface, i.e. the portion which is not diffracted and which is thus not given the desired direction of deflection. This loss of intensity must be compensated by a correction value. On the other hand, the larger the wedge angle, the greater is the compression of the bundle of rays. The compression of the bundles of rays causes the energy in the observer plane to be increasingly distributed to areas which lie outside the visibility region. This energy does not reach the detected observer eye, so that a generated reconstruction appears too dark. This loss of intensity must be compensated by a correction value too.

The intensities of the respective modulator cells must thus be increased at least for a one-dimensional deflection by introducing a correction value by the control means which is the sum of the two above-mentioned correction values. This deflection-angle-dependent cumulative correction value is stored in and can be retrieved from a correction value table for each modulator cell. Alternatively, a correcting of the intensities is also possible directly by way of accordingly controlling coherent light emitting light sources.

Another important measure when realising large deflection angles is to dispose at least one polarisation means 12 in the optical path as shown in FIG. 5b, since disturbing phase jumps occur at large deflection angles. The polarisation means 12 is disposed in the optical path such that it gives the bundle of rays 1 an input polarisation \vec{E}_{S} perpendicular to a plane along which the visibility region is tracked to the observer eye 9. Referring to FIG. 5a, this plane is the X-Z plane. The tracking range of the bundle of rays 1 is confined by the maximum realisable deflection angles of the prism cells 5, 6.

The above-mentioned measures aim to counteract the compression of the bundles of rays which is caused by the deflection by the interfaces and to minimise this compression of the bundles of rays. This is done one-dimensionally in the described embodiments. In the incoherent direction, the diffraction patterns of all deflection devices are superposed incoherently in the visibility region, i.e. their intensities are added in the region where the observer eye is situated. This incoherent superposition of intensity distributions corresponds with the generation of a visibility region in stereoscopic display devices. This means that the problem of the compression of the bundles of rays and the corresponding effects also occurs in the optical path in an autostereoscopic display with EW cells when visibility regions are generated for each eye. The energy which is assigned to a visibility region again spreads the more in horizontal direction the greater the compression of the bundles of rays, i.e. the smaller the cross-section of the bundles of rays downstream the individual deflection devices after the deflection. The amount of energy which can be perceived by the detected eye pupil thus decreases as the deflection angle and thus the compression of the bundles of rays becomes larger. The amount of energy which gets into the eye pupil of the other eye rises at the same time. The compression of the bundles of rays causes cross-talking of intensities to the non-detected eye also in autostereoscopic displays.

It shall also be covered by this invention to solve the above-mentioned problem two-dimensionally. When doing so, it must be noted that the compressed cross-section of the bundles of rays depends on the position of the observer eyes and on the number of the serially generated micro-prisms per prism cell.

In order not to start tracking the visibility region by the control means immediately already when the observer eye only moves marginally, the visibility region is enlarged in a locally confined manner at the position of the detected observer eye. This can be achieved in that the visibility region which is generated at that eye position additionally performs a fast periodic lateral excursion. For this, the control means generate additional control values which are added as phase signals and/or amplitude signals to the values which are encoded on the light modulator and/or to the control values for the prism cells. The additional control signals are determined depending on the actual deflection angle of the observer eyes and on an angle which corresponds with the locally confined excursion. In more specific terms, e.g. a sinusoidal voltage signal is modulated e.g. onto the control signal of a prism.

In order to be able to track the visibility region continuously in a holographic display, a phase shift is required in addition to the variably controllable prism function. Its value is direction-dependent. It takes into account whether the visibility region is to be tracked from left to right or vice versa. This value is preferably also provided by the control means for the modulator cells in addition to the complex encoding values.

A holographic direct-view display with a light modulator device which comprises controllable deflection devices according to this invention with prism function based on electrowetting cells can perceivably reduce cross-talking through at least one of the above-mentioned measures and thus realise the function of tracking respectively assigned visibility regions for multiple observers. The quality of the generated reconstruction is thereby improved.

### REFERENCE NUMERALS

1 Bundle of rays
2 Modulator cell
3 Effective area of the modulator cell
4 Prism cell
5 to 8 Micro-prisms
55; 66 Wedge angle
9 Observer eye
10 Observer plane
11 Tracking range
a; b Extent of an incident bundle of rays
a′; b′ Extent of an exiting compressed bundle of rays
c; c′ Cross-sectional area of a bundle of rays before and after the compression
CM Control means
PF Position detection system
Uαᵢⱼ1, . . . Uαᵢⱼn Electrodes of the prism cells
Umᵢⱼ Electrodes of the modulator cells

1. Controllable deflection device comprising a controllable prism cell and a controllable electrode arrangement,
Where the prism cell contains multiple immiscible materials and is assigned to a controllable modulator cell which is disposed upstream in the optical path and which is illuminated by a bundle of rays with a defined intensity distribution, and
Where the electrode arrangement controls interfaces which are formed between two immiscible materials in the prism cell for deflecting the bundle of rays towards a detected observer eye in a visibility region, where the deflected bundle of rays exhibits in the visibility region an intensity distribution of the diffraction patterns of the modulator cell which is changed compared with the defined intensity distribution,
Wherein the changed intensity distribution in the visibility region is compensated in the optical path of the bundle of rays by reducing the intensities of side peaks of higher diffraction orders in that the effective area of a modulator cell has a shape which is adapted to the changed intensity distribution and/or in that the materials which are used in the prism cell generate a homogeneous refractive power distribution at the interfaces.

2. Controllable deflection device according to claim 1, which serves a tracking range in which the coherent bundles of rays which generate the visibility region are deflected in accordance with the change in the position of observer eyes in that tracking range.

3. Controllable deflection device according to claim 1, wherein the effective area of a modulator cell has the greatest extent in the direction where the corresponding prism cell generates the greatest deflection of the bundle of rays.

4. Controllable deflection device according to claim 1, wherein a prism cell has at least four interfaces of which at least two interfaces between three materials are variably inclined as a voltage is applied such that the refractive power is distributed as homogeneously as possible across the materials.

5. Controllable deflection device according to claim 2, wherein at least one polarisation means is provided in the optical path to prevent phase jumps in the tracking range while tracking the visibility region, where said polarisation means gives the bundle of rays to be deflected an input polarisation perpendicular to a plane along which the tracking is performed.

6. Controllable deflection device according to claim 1, wherein each modulator cell is given additional intensity values, which serve as correction values, by the control means as soon as the loss of energy of the coherent bundles of rays caused by the deflection and by reflections exceeds a given value.

7. Controllable deflection device according to claim 6, wherein the correction values are stored in and can be retrieved from a correction value table at least for a one-dimensional deflection with continuous value pattern.

8. Controllable deflection device according to claim 2, wherein control means additionally generate control signals for a fast periodic lateral excursion of the generated visibility region at the position of the detected observer eye to expand the visibility region for that observer eye in a locally confined manner.

9. Controllable deflection device according to claim 7, wherein the additionally generated control values are added as phase signals and/or amplitude signals to the control values of the prism cells and/or to the values which are encoded in the modulator cells.

10. Controllable deflection device according to claim 2, wherein multiple horizontally and/or vertically arranged prism cells are combined to form a group of prism cells which are addressed as one unit, where the angular difference of the bundles of rays in relation to an observer eye which is to be realised between two adjacent prism cells lies below a threshold value.

11. Light modulator comprising at least one controllable deflection device according to claim 1 in whose modulator cells complex values of the hologram of a holographic reconstruction to be generated are encoded and which is passed through by coherent bundles of rays with a defined intensity distribution which, after diffraction by the modulator cells and by the corresponding downstream deflecting prism cells, are superposed as an intensity distribution of diffraction patterns of the modulator cells in the visibility region, where the diffraction patterns correspond with the individual modulator cells and with the corresponding downstream deflecting prism cells and exhibit after the deflection a changed intensity distribution in the visibility region, which is compensated by reducing the intensities of the side peaks of the higher diffraction orders such that the effective area of a modulator cell has a shape which is adapted to the changed intensity distribution and/or that the materials which are used in the prism cell generate a homogeneous refractive power distribution at their interfaces.

12. Light modulator device comprising a light modulator according to claim 11, which comprises a multitude of regularly arranged modulator cells, where a modulator cell is assigned with a controllable deflection device according to claim 1.

13. Holographic display device which comprises a light modulator device according to claim 11.
